(19) United States
(12) Patent Application Publication
(10) Pub. No.: US 2011/0000295 A1
(43) Pub. Date: Jan. 6, 2011

(54) REMOTE LEVEL GAUGE ADAPTED FOR LIQUID FUEL TANK

(75) Inventor: Mark Kritlow, Concord, NH (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Windward Petroleum, Manchester, NH (US)

(21) Appl. No.: 12/496,360

(22) Filed: Jul. 1, 2009

(51) Int. Cl. G01F 23/14

(52) U.S. Cl. 73/299

(57) ABSTRACT

An apparatus for sensing a fluid level that, in one embodiment, is adapted to fit the threads of a fill pipe or vent cap in a storage tank. A first (or upper) part of the assembly is secured in an upper portion of the tank (such as is provided at a threaded vent opening) and includes components to permit sensing pressure at a first location. A second (lower) portion of the assembly sensing pressure at a second location is disposed in a weighted casing. The second portion is coupled to the first portion through a cable that carries a section of tubing. Circuitry disposed in the second portion receives a pressure indication from the upper portion through the tubing, and detects a fluid pressure at both the upper and lower portion of the tank. The difference between the two pressures is indicative of fluid level. This level is then sent back up to the electronics assembly in the first (upper) portion. The electronics assembly can contain a microprocessor and a radio transmitter, such as a cellular or other wireless data network transmitter, to report the fluid level to a remote station such as operated by a fuel supplier. In more particular aspects, the reports of fluid levels can be delayed until periods of significantly less change in fluid level or an indication that use of the tank as stopped, to save battery life.

### BACKGROUND

This patent application relates to bulk fluid tank level monitoring, and more particularly to a differential pressure sensor which can be retrofit to existing tanks.

A large number of homes and businesses the store fluids in bulk on their own property prior to or after use. As one example, liquid fuels are stored in fluid tanks and are drawn down as needed for heating, cooking, hot water and other uses. Such stored fluids may include oil, natural gas, liquid propane or other fuels. In another example, businesses may store spent fluids in bulk such as lubricating oils, coolants, and other waste industrial fluids after their use.

In rural and other remote areas where a pipeline system does not exist, tank trucks must travel to service the individual tank locations. There are two common arrangements by which a service company schedules visits. In a first arrangement, periodic visits are made, depending on the size of the tank and predicted utilizations of storage capacities. Periodic visits may be scheduled monthly, for example. Such visits need to be carefully planned so that the customer will not run out of product or waste storage space before the next scheduled visit. The visit schedule may also depend on expected demand, which may rise and fall depending upon the season of the year, geographical location, historical use and other factors. For example, in cold weather climates, the visit schedule to a fuel tank should be more aggressive in the winter if the fuel is being used for heating.

In a second arrangement, the customer is on a “will call” plan where a truck does not come out unless the customer places a call. With that approach, the customer is responsible for periodically checking a level gauge to determine if a visit is necessary. Many customers like this arrangement because visit costs are incurred only when service is actually necessary.

A problem with these approaches is that they result in unnecessary charges for a truck traveling to the installation in instances when it may not be time to service the tank. Customers also do not like to see extra delivery charges, especially around the winter holidays. It is also likely that customers procrastinate in checking their tank levels, especially during extreme cold or holiday periods, and the like.

Some have proposed the use of automatic tank level monitoring systems. These can include an electronic tank level gauge coupled to a computer and radio transmitter. The electronic tank level gauge detects a fluid level in the tank and provides information to a microcomputer. The microcomputer then periodically monitors the output from the fuel gauge and causes that information to be transmitted via a cellular or other wireless link to another computer accessible by the service company. The service company is thus then kept apprised of the tank level and can then schedule visits only when the tank requires it. Such systems are described, for example, in U.S. Pat. No. 7,155,349 issued to Souleur and U.S. Pat. No. 7,441,569 issued to Lease.

### SUMMARY OF THE INVENTION

It is thus known to improve the logistical inefficiencies associated with visiting storage tanks in remote locations by using an electronic level gauge and a radio transmitter for reporting the fluid level to a tank service provider location. However, the system components used for measuring the fuel level have to date been relatively expensive. They typically require specially designed storage tanks that incorporate the required electronic level sensors or a precise mechanical retrofit to existing tanks.

In pertinent aspects, an embodiment of a system to which this patent is directed includes a sensor device that is inexpensive and easily retrofit to an existing fluid storage tank. The sensor is embedded in an assembly adapted to fit into a standard threaded filler or vent opening in the tank.

More particularly, the assembly consists of a base unit having, in one embodiment, a portion adapted to fit the threads of a fill pipe or vent cap. This first (or upper) part of the assembly is secured in an upper portion of the fluid storage tank (such as is provided at a threaded vent opening) and includes components to permit sensing pressure at a first location. A second (lower) portion of the assembly is disposed in a weighted casing. The second portion is coupled to the first portion through a cable. Circuitry disposed in the second portion receives a pressure indication from the upper portion through tubing in the cable, and also detects a fluid pressure at the lower portion of the tank. The difference between the two pressures is indicative of fluid level. This level is then sent back up to the electronics assembly in the first (upper) portion. The electronics assembly contains a microprocessor and a radio transmitter, such as a cellular mobile telephone transmitter, to report the fluid level to a remote monitoring station.

In more particular aspects, the fluid level reports can be delayed until periods of (a) significantly less change in fluid level, or (b) a detected reduction in continuous use. This reporting scheme can save battery life as it does not require clocks or periodic check while remaining responsive to actual demand.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a perspective diagram of a fluid storage tank into which the inventive apparatus has been installed.

FIGS. 2A and 2B are a more detailed view of the lower portion of the assembly.

FIG. 3 is a more detailed view of the cable.

FIG. 4 is a partial view of the upper portion of the assembly, showing the arrangement of a vent tube in more detail.

FIG. 5 is a flow chart for one implementation of a fluid level reporting process.

FIG. 6 is a flow chart for another reporting process.

### DETAILED DESCRIPTION OF EMBODIMENTS

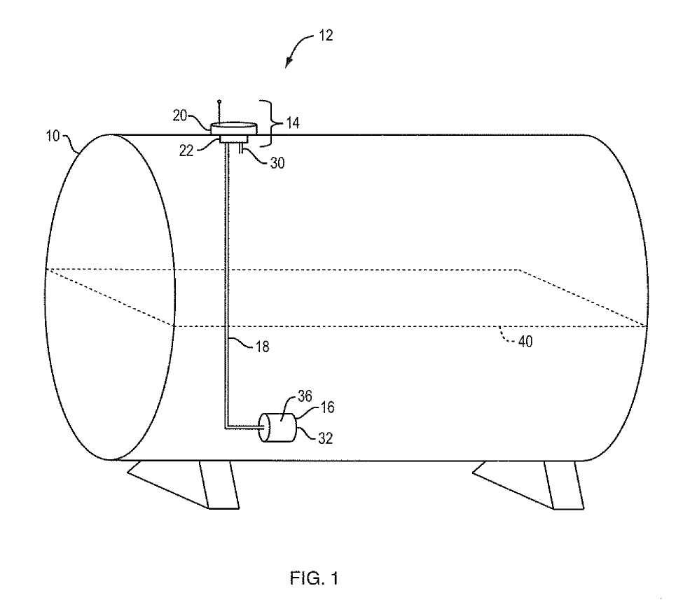

FIG. 1 is a schematic view of a fluid storage tank. The fluid storage tank may be, by way of a non-limiting example, a domestic fuel oil tank installed inside a residence. As another example, the fluid tank may be used for storing waste liquids in bulk, such as at a manufacturing plant. In pertinent portions a remote wireless fluid level sensor 12 is fitted to the tank and consists of an upper portion 14, a lower portion 16, and a cable 18 connecting the upper 14 and lower 16 portions. The upper portion 14 consists of an electronics subassembly 20 and threaded carrier 22. Electronics subassembly 20 includes a cellular mobile or other wireless data transmitter, a power source and a microprocessor (not shown in detail). The sensor 12 may be inexpensive enough to be disposable.

The power source may be one or more direct current batteries that are easily and inexpensively replaced.

The microprocessor controls the radio equipment and receives pressure sensor signals, or preferably, a differential pressure signal desired from pressure measurements taken at both an upper vent opening 30 and a lower vent opening 32. As will be described in more detail below, the lower vent opening 32 is provided by the lower portion 16. The upper vent opening 30 is thus in fluid communication with a pressure sensor 36 in the lower portion 16 via a tubing section in cable 18 (not shown in FIG. 1). In this way, a sensor 36 within the lower portion 16 can determine a fluid pressure differential measured near the bottom of the tank 10 to a pressure measured at the top of the tank 10. The pressure difference is indicative of the fluid level 40 inside tank 10.

The cable 18 should be at least somewhat longer than the height of the tank 10. In particular, it should be long enough to allow the lower portion 16 to lie on its side on the bottom of the tank 10, resulting in lower vent opening 32 resting at a relatively known distance from the bottom of the tank. For example, if the cable 18 is long enough, the distance from lower vent opening 32 to the bottom of tank 10 is then set by the diameter of the cylindrical housing for lower portion 16. This permits accurate conversion of a pressure measurement to fluid level, since the lower pressure will always be taken at a predictable distance from the bottom of the tank 10. The lower portion 16 is also preferably weighted so that it will remain on the bottom of the tank 10 even when the fuel level 40 is relatively high or low, e.g., through a range of fuel levels 40.

To install the device, one merely needs to remove an existing threaded filler cap or vent opening and begin feeding the lower portion 16 through the opening. The cable 18 is then fed through the same opening. Finally, the upper portion 14 is secured into the threaded opening.

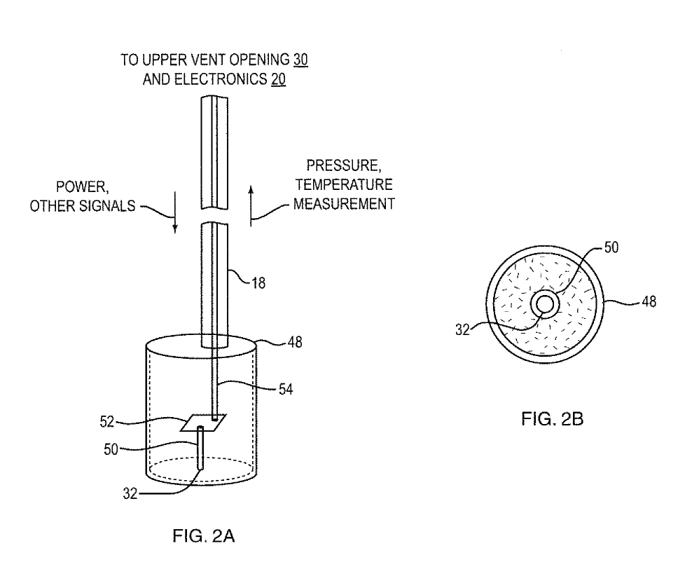

FIG. 2A shows more detail of the lower portion 16. It consists of a cylindrical casing 48, such as may be formed of cast iron or other metal providing enough weight so that the lower portion 16 reliably sinks to and remains on the bottom of the tank 10. The lower vent opening 32 is provided by a section of tubing 50 that feeds from a pressure sensor integrated circuit 52. A second section of tubing 54 is also coupled to the pressure sensor circuit 52 and fed via cable 18 back up to the top portion of tank 10 to provide the upper pressure measurement.

Pressure sensor 52 is a differential electronic pressure sensor. Sensor 52 may preferably be encased inside cylindrical housing 48, such as via an epoxy, a polymer, or other low coefficient of expansion materials. The sensor 52 may take the form of a hydrostatic or ultrasonic sensor, but in practice, it is preferred to have a differential hydrostatic pressure measurement to determine a difference between the fluid pressure at the top of the tank and the bottom of the tank. Sensor 52 thus provides electrical signals indicative of a pressure differential.

Other circuits in lower portion 16 can also measure temperature and other parameters within the tank.

In operation, sensor 52 receives the fluid pressure at both the lower portion of the tank as provided from lower vent opening 32 via tubing 50, as well as a fluid pressure at upper portion of tank 10 provided via tubing 54 that runs through cable 18 in communication with the upper vent opening 30.

With regard to the other functions of cable 18, power and other electrical signals are fed through embedded wires therein between sensor 52 and electronics assembly in the upper portion 14.

FIG. 2B is a bottom view of casing 48, showing the lower vent tube 32 in more detail. Here it is seen how the lower vent tube 32 provides an opening for fluid to enter through tube 50 so that it might reach sensor 52.

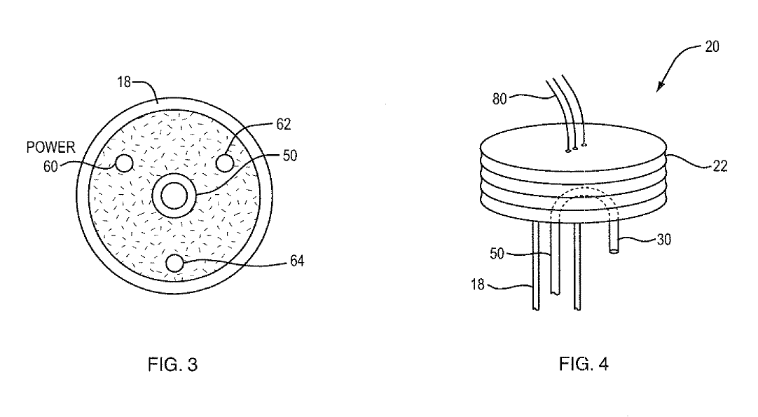

FIG. 3 is a cross sectional view of cable 18. It contains a section of tubing 50 as well as three or more wires, including at least a wire for power 60 and ground 62 and at least one signal 64. If only a single signal wire 64 is provided, a serial communication interface can be used between the electronics 20 and the sensor 52 to communicate pressure, temperature and other information. In other instances, multiple wires may be provided to present signals in parallel through cable 18.

FIG. 4 is a more detailed view of the threaded portion 22 of the upper subassembly 20. It is seen that tube section 50 fed from cable 18 is held in place and then routed through a portion of lower portion 22. Vent tube 33 again exits upper section 20 so that its end opening is in the upper portion of the tank 10 when installed.

It should be noted that the exact shape of the upper portion is not important. However, it preferably provides a good seal when installed in the tank opening, is disposable, and of low cost. It can be formed of polyvinyl chloride (PVC) or other plastic material.

Keeping vent 50 entirely within the confines of the tank when level sensor 12 is installed avoids a problem that might otherwise occur. For example, if a vacuum were to build up in the tank 10, it does not matter with this configuration. In other instances a problem could occur where one might compare, for example, the lower tank pressure with external ambient pressure. If a vacuum builds up inside the tank 10 in such a system (e.g., when fluid level 40 is depleted) this would lead to errors in detecting the pressure differential. However, with the scheme shown herein, with both pressure sensors within the tank, a differential calculation between pressure at the upper portion of the tank and in the lower portion of the tank can always give a reliable indication of fluid level 40.

In certain instances, the microprocessor in upper portion 14 can observe one or more particular techniques for conserving battery power while still being responsive to the storage tank usage patterns. For example, as long as the fluid level 40 is detected to be changing (or constant) over a certain amount of time, the level information is simply stored locally and not transmitted, to save battery power. However, once the level settles out (or stops changing), the computer can be programmed to transmit the settled level and any immediate prior history of the fluid level. These techniques have been found to be more efficient than having a periodic time based reporting mechanism, which requires continuously active clock circuitry that drains batter power.

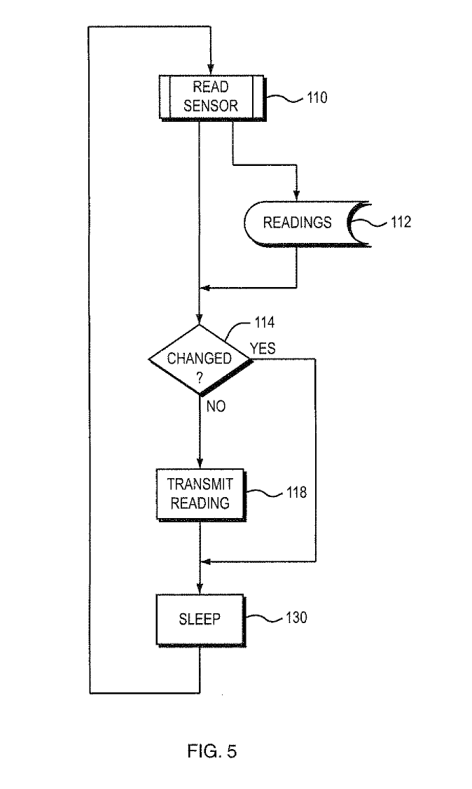

More particularly, a process flow diagram for one preferred reporting process used by the microprocessor might proceed as in FIG. 5. In a first state 110, the fluid level is detected by reading sensor 52. In state 112 this level is stored. State 114 is then entered in which the current level is compared against the previous level within a predetermined threshold amount. If this level has changed more than a the threshold amount since the prior measurement, then the process proceeds directly to state 118 where a report will be made. Processing then proceeds within state 130 where a period of time elapses before step 110 is entered again, and the fluid level is again detected. Thus a report is made if, in state 114, the difference between this fluid level measurement and a prior fluid level measurement exceeds a threshold, indicating that the tank is being used. This report need only include the current fluid level, since it is not now changing. After reporting the fluid level in state 118, processing continues to the wait state 130.

If however in state 114, there has not been a change more than a threshold amount, then state 130 is entered and no report will be made. In state 130, The microprocessor enters a low power hibernation mode to conserve battery power. After a waiting period, the process will return again to state 110 to detect new fluid levels once again.

Using this process, during periods of low tank utilization, data traffic and hence battery power are reduced considerably. However, once usage starts, a detailed report is made. The savings can occur, for example, at night when usage is low. If this report occurs with a relatively high fuel level still in the tank, it can indicate a period of time in which the homeowner is not utilizing fuel and visit need not be made.

In addition, the threshold amount in step 114 and the waiting period in step 130 can be adjusted based on an expected demand.

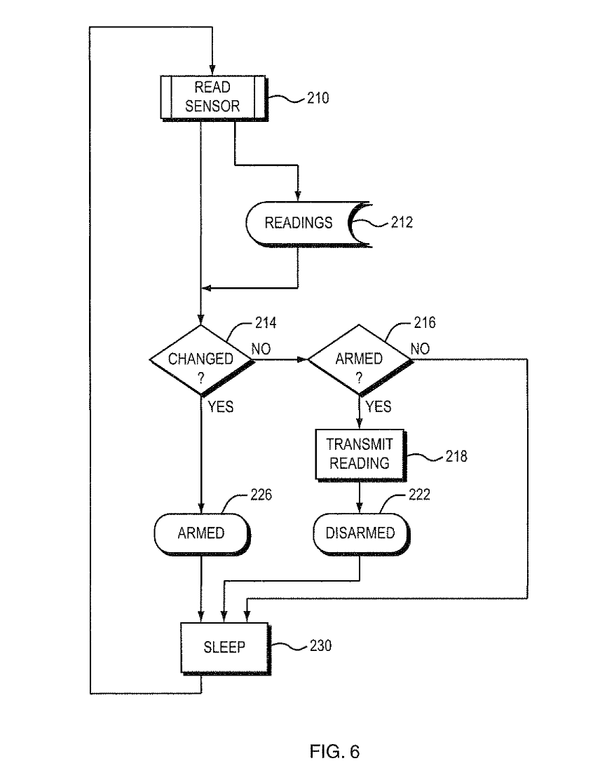

Another preferred reporting process that is the inverse, but not identical, may be used by the microprocessor as shown in FIG. 6. This process is geared more towards detecting when a pattern of continuous use of the tank has ended. In particular, readings are logged while the tank is active, and then reported when the tank enters a quiescent state. More particularly, this process begins similar to that of FIG. 5 but detects a stoppage in usage rather than a change greater than a certain threshold amount.

In a first state 210 the sensor 52 is read and the fluid level is detected. This level is then stored in state 212. Next, the level is compared in state 214 to a previously measured level to determine if there has been a change in fluid level over time. This indicates that the tank is still being utilized. If so, then the process proceeds to state 220 where the processor sets an armed state flag. Processing then proceeds to a wait state 230 where a period of time elapses before state 210 is entered again, and the fluid level is detected again. Thus, no report is made if in state 214 it is determined that the tank is being utilized.

From state 214 if a constant fluid level (indicated by little or no change in the sensor reading) indicates that the tank is no longer in use then state 216 is entered where it is concluded that the tank is now no longer in use. For example, this may occur at night during a time when product is not being consumed, or a waste fluid tank has not been filled in some time. In state 216, if the process has set the armed flag, state 218 is entered, where the history of usage will then be reported to the remote service location. After setting the disarm state for the flag in state 222, the process proceeds to wait a period of time in state 230, before the fluid level will then be again detected by re-entering state 210.

From state 216, if the armed state is not set, then the sleep state 230 is entered directly, without making a report. Note particularly that no report is made of the fluid level at this point in order to further save battery power until the tank is being used again. Processing instead then returns to the wait state 230 where a period of time elapses before the fluid level detection process beginning with state 210 begins once again.

Thus, in one process, depicted in FIG. 5, information is only sent when fluid level changes in the tank. In another process, depicted in FIG. 6, information is sent only when there is some stoppage in utilization of the fluid tank, and not again until usage stops again.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus for sensing a condition within in a tank comprising:
an upper portion having an upper opening into the tank;
a lower portion, having a lower opening into the tank;
a tubing section, extending between the upper portion and the lower portion, the upper end coupled to the upper opening; and
a differential pressure sensor, located in the lower portion and coupled to the lower opening and the tubing, to determine a differential pressure measurement between the upper and lower openings.

2. The apparatus of claim 1 additionally comprising:
a cable, coupling the differential pressure measurement as an electrical signal to the upper portion.

3. The apparatus of claim 2 additionally comprising:
a power source, located in the upper portion; and
wherein the cable additionally couples a power signal to the differential pressure sensor.

4. The apparatus of claim 1 wherein the upper portion further comprises a base member having external threads adapted to be fit to a fill opening in the tank.

5. The apparatus of claim 1 additionally comprising:
a wireless transmitter, disposed in the upper portion, for transmitting information to a location remote from the tank.

6. The apparatus of claim 1 wherein the differential pressure measurement is indicative of fluid level in the tank.

7. The apparatus of claim 1 wherein the lower portion further comprises a cylindrical housing having the lower opening disposed along a central axis thereof.

8. A method for reporting a condition within a fluid storage tank to a remote location comprising the steps of:
(a) sensing a fluid level at a first time;
(b) sensing the fluid level at a second time later than the first time;
(c) determining a difference between the fluid levels sensed at the first and second times;
(d) comparing the difference between fluid levels to a threshold;
(e) if the difference in fluid levels exceeds a threshold or indicates constant use, then
(i) storing the fluid level information; and
(ii) returning to step (a) without reporting to the remote location;
(f) if the difference in fluid levels does not exceed a threshold or indicates a stoppage in use, then
(iii) reporting the sensed fluid levels and any prior stored fluid levels to the remote location; and
(iv) returning to step (a).

9. The method of claim 8 wherein if a fluid level is below a threshold amount, a report of fluid level is made regardless of the difference in fluid levels measured at the first and second sensing steps.

10. The method of claim 8 further comprising, prior to step (iv), a step of
(f) sensing the fluid level again;
(g) if the level sensed in step (g) indicates the fluid tank is being used again, returns to step (a) without reporting to the remote location, otherwise, waiting and then returning to step (f).
